(19) United States
(12) Patent Application Publication
(10) Pub. No.: US 2007/0137495 A1
(43) Pub. Date: Jun. 21, 2007

(54) Coffee maker with grinder

(76) Inventor: Lewis M. Talbert, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/303,870

(22) Filed: Dec. 16, 2005

(51) Int. Cl. A47J 31/42

(52) U.S. Cl. 99/286

(57) ABSTRACT

A coffee maker may include a reservoir section and a grinding section coupled to the reservoir section. The reservoir section and the grinding section are may be included in an internal volume of a container. A grinder is disposed in the grinding section. The coffee maker includes a filter between the grinding section and the reservoir section. In certain embodiments, a grinding section, reservoir section, and a pressing element are contained with one chamber. In certain embodiments, the grinder grinds coffee beans while the coffee beans are in water. The container may dispense coffee from the reservoir section when the container is tipped.

### BACKGROUND

1. Field of the Invention

Embodiments of the invention generally relate to devices and methods for preparing hot beverages. More specifically, embodiments of the invention relate to devices for grinding coffee beans and making coffee from the produced coffee grounds and methods of making and using such devices.

2. Description of Related Art

Many devices are known for making coffee in home and commercial settings. In a typical coffee making device, the user loads coffee grounds into a container in or on the device. The device causes hot water to come into contact with the coffee grounds such that water soluble components from the coffee grounds are extracted by the water. The rest of the coffee grounds are then filtered from the mixture, resulting in hot coffee.

One type of coffee maker is referred to as a French press or press pot. The French press includes a cylindrical glass container with a plunger that slides vertically within the container. The head of the plunger includes a filter. To make a pot of coffee, the plunger is removed from the container and coarse grounds are placed in the bottom of the container. Hot water is then added and stirred with the grounds. After allowing the coffee to steep for an appropriate length of time, the plunger is applied against the grounds. Water and water soluble components from the coffee grounds pass through the filter. The resulting product is served from the container.

The freshness of the coffee grounds significantly affects the quality of the coffee. After coffee beans are ground, the freshness of coffee grounds may decline fairly rapidly over time. As a result, the flavor of the coffee made from such grounds deteriorates. In addition, some of the flavor of the coffee is lost to the surroundings (e.g., in the form of volatile compounds becoming airborne) during and after grinding of the beans. It is therefore desirable to make coffee as soon as possible after the coffee beans are ground. It is further desirable to capture the organic compounds in the grounds that might otherwise dissipate into the environment.

### SUMMARY

Various embodiments of coffee makers and methods for making coffee are described. In an embodiment, a coffee maker includes a reservoir section and a grinding section coupled to the reservoir section. Fluid can flow from the grinding section to the reservoir section or from the reservoir section to the grinding section. A grinder is at least partially disposed in the grinding section. The coffee maker may include a filter between the grinding section and the reservoir section. In certain embodiments, the grinder grinds coffee beans while the coffee beans are in water.

In some embodiments, the reservoir section and the grinding section are included in one chamber (e.g., the internal volume of a container). The container may dispense coffee from the reservoir section when the container is tipped. In certain embodiments, the container may include a handle coupled to the container. The handle may be operable by a user to tip the container to pour coffee from the reservoir section.

In some embodiments, a grinding section is above a reservoir section. In other embodiments, a grinding section is below a reservoir section. In one embodiment, a grinding section is at or proximate to the bottom of the internal volume, and at least a portion of the reservoir section is at or proximate to the top of the internal volume.

In some embodiments, a coffee maker includes a pressing element. The pressing element may be in the same chamber as the grinder. The pressing element may apply pressure to squeeze water soluble components from coffee grounds in a grinding section of the coffee maker. In some embodiments, a grinder and a pressing element reside in a common container. In certain embodiments, a pressing element includes a piston that slides within a chamber of the container.

In some embodiments, a coffee maker includes a water delivery system. The water delivery system may deliver water to coffee grounds in the grinding section. The filter may allow a mixture of water and water soluble components from the coffee grounds to pass into the reservoir section. In one embodiment, the water delivery system forces a mixture of water and water soluble components from the coffee grounds through the filter and into the reservoir section.

In some embodiments, a coffee maker includes a heating element. The heating element may heat coffee in the reservoir section. In one embodiment, a heating element is a flameless chemical heater.

In some embodiments, a coffee maker includes a driving mechanism for a grinder. In one embodiment, a driving mechanism includes a motor. In another embodiment, a driving mechanism includes a manual crank.

In an embodiment, a coffee maker includes a container and a base. The container may include a reservoir section and a grinding section. A grinder may be disposed in the grinding section. The container is removable from the base to allow coffee to be poured from the container. The base may include a motor that drives the grinder. In some embodiments, a base includes a water delivery system that delivers water to the grinding section. In certain embodiments, the water delivery system forces a mixture of water and compounds from coffee grounds through the filter and into the reservoir section. The water delivery system may include a supply line coupled to the grinding section. A heating element in the base may heat water in the supply line before the water enters the grinding section.

In an embodiment, a container includes a reservoir section and a grinding section. A grinder may be coupled to the container. The coffee maker holds water in the grinding section such that coffee beans are at least partially submersed in water when the coffee beans are ground. The coffee maker may have one or more seals that inhibit water leakage from the grinding section. In certain embodiments, the grinding section and the reservoir section are one section. For example, the grinding section and the reservoir section may both be the internal volume of a container.

In an embodiment, a method of making coffee includes grinding coffee beans in a container to form coffee grounds, forming a mixture of water soluble components from the coffee grounds and water in the container, forcing the mixture through a filter into a reservoir section of the container, and brewing coffee from the mixture in the container. The coffee beans may have at least partially submersed in water before grinding the coffee beans in the container. In some embodiments, forming the mixture of water soluble components from the coffee grounds and water includes pressing the coffee grounds.

In some embodiments, brewing the coffee includes allowing the mixture to steep in the reservoir section. Brewed coffee may be poured from the reservoir section. In certain embodiments, the coffee grounds are filtered from the coffee as the coffee is poured from the reservoir section. In one embodiment, the method may include activating a heating element to heat water in the container.

In some embodiments, coffee beans submersed in water in a container may be agitated during the grindring and/or brewing process. In one embodiment, coffee beans are agitated in the container during grinding or brewing by operating a grinder.

### BRIEF DESCRIPTION OF THE DRAWINGS

Advantages of the present invention will become apparent to those skilled in the art with the benefit of the following detailed description and upon reference to the accompanying drawings in which:

FIG. 1 depicts a coffee maker including a blade grinder and a plunger.

FIG. 2 is a cross-sectional view a coffee maker with coffee beans prior to grinding.

FIG. 3 is a cross-sectional view of a coffee maker with coffee beans and water prior to grinding.

FIG. 4 is a cross-sectional view of a coffee maker after grinding of the coffee beans.

FIG. 5 is a cross-sectional view of a coffee maker after applying a piston to a mixture of coffee grounds and water.

FIG. 6 is a top view of a coffee maker including a container unit and a base unit.

FIG. 7 is a cross-sectional view of the coffee maker shown in FIG. 6 taken. substantially along lines 7-7 in FIG. 6.

FIG. 8 is a top view of a coffee maker and dispenser including a built-in grinder and a built-in heating element.

FIG. 9 is a cross-sectional view of the coffee maker shown in FIG. 8 taken substantially along lines 9-9 in FIG. 8.

FIG. 10 is a cross-sectional view of a cylindrical coffee maker having a top grinder.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

In some embodiments, a coffee maker may process coffee beans into grounds, filter the grounds, brew coffee, and/or dispense the coffee. As used herein, “brewing” includes various ways of producing coffee such as steeping, drip brewing, or boiling.

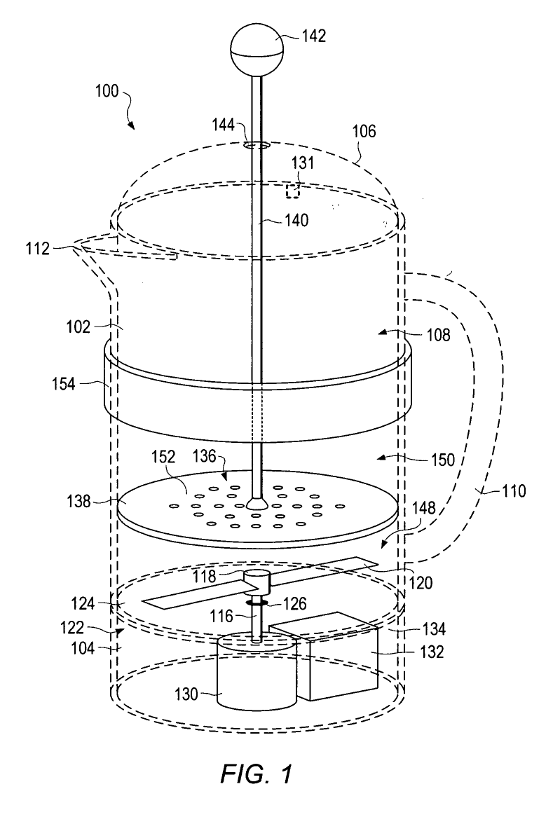

FIG. 1 depicts coffee maker 100 including container 102, base 104, and lid 106. Container 102 may define internal volume 108. Coffee maker may include handle 110 and spout 112. In one embodiment, container 102 is generally cylindrical. A container may be various other shapes, such as spherical, cubic, conical, pear-shaped, rectangular, or irregular. Suitable materials for a container include, but are not limited to, metal, metal alloy, glass, ceramic, or a polymer. In one embodiment, container is made a shatterproof glass that is designed to withstand high thermal gradients.

In some embodiments, a coffee maker may include, or be coupled to, a coffee grinder. Suitable grinders may include, but are not limited to, conical burr grinders, disk burr grinders, and blade grinders. Grinders may produce coffee grounds by various operations such as crushing, tearing, chopping, or pounding coffee beans. As shown in FIG. 1, coffee maker 100 may include blade grinder 114. Blade grinder 114 may include shaft 116, hub 118, and blades 120. Blades 120 may chop coffee beans in bottom portion 122 of container 102 into coffee grounds. Although only two blades are shown in FIG. 1, a blade grinder may in other embodiments have a single blade or more than two blades or a single blade. Blades may be various shapes and sizes.

Shaft 116 of blade grinder 114 may pass through bottom wall 124 of container 102. Bottom wall 124 may include seal 126. Seal 126 may inhibit leakage from container 102. In some embodiments, seal 126 may be made of an elastomeric polymer (e.g., an ethylene propylene). Seal 126 may be selected from a material that is suitable for potable applications. In one embodiment, seal 126 is an o-ring.

A grinder may include, or be coupled to, a driving mechanism. For example, as shown in FIG. 1, shaft 116 of grinder 110 may be coupled to motor 130. In some embodiments, shaft 116 may be coupled directly to the output shaft of motor 130. In other embodiments, shaft 116 may be coupled to the output shaft of motor 130 through intermediate elements, such as a gearbox or u-joint. Other driving mechanisms include, but are not limited to, a hand crank, a lever, or a power tool (e.g., a portable electric drill). In some embodiments, a coffee maker may have a safety switch to inhibit injury to a user. For example, a safety switch may shut off power to a motor if a finger of the user comes into contact with a grinding head, or a door on the coffee maker is open. As shown in FIG. 1, coffee maker 100 may have safety switch 131. Safety switch 131 may be electrically coupled to motor 130. Safety switch 131 may open to inhibit operation of motor 130 if lid 106 is removed from container 102. In another embodiment, a safety switch may activate when more than a predetermined amount of resistance is applied to blade of a grinder.

In one embodiment, motor 130 is an electric motor. Motor 130 may be electrically coupled to battery 132. Battery 132 may provide power to drive motor 130. Battery 132 may be one of various types, such as lead-acid, nickel-cadmium, nickel-metal hydride, or lithium ion. In certain embodiments, motor 130 may receive power from an external source (e.g., a household wall receptacle, an automobile cigarette lighter adapter). Motor 130 and battery 132 may be enclosed in base housing 134. Base housing 134 may have a bottom that is open or closed. In one embodiment, coffee maker 100 may rest on bottom edges of base housing 134 when coffee maker 100 is placed on a flat surface.

Coffee maker 100 may include plunger 136. Plunger 136 may include piston 138, rod 140, and knob 142. Piston 138 may be coupled to rod 140. Rod 140 may couple with lid 106 through hole 144 in the lid. Rod 140 may slide in hole 144 so that a user can raise or lower piston 138 in internal volume 108. Plunger 136 may be operable to apply a pressure to coffee beans and coffee grounds in container 102. Plunger 136 may squeeze water soluble components from coffee grounds in container 102. A user may grasp knob 142 to exert a manual force on rod 140. As used herein, a “piston” includes any element that moves up and down in an internal volume of a container. A piston may have forms, including, but not limited to, cylindrical plug, a flat plate, a curved (e.g., convex) plate, a disc, or a block. Pistons may be various shapes, including but not limited to, circular, ovate, or rectangular. In some embodiments, the outer sides of a piston may fit slugly against the inner sides of a container. In other embodiments, gaps may exist between the outer sides of a piston and a cylinder.

In an embodiment, a coffee maker includes a grinding section and a reservoir section. As used herein, a “grinding section” includes a section of a device in which material (e.g., coffee beans) is ground. As used herein, a “reservoir section” includes a section of a device in which liquid (e.g., coffee) is collected or held. For example, a reservoir section may hold coffee during or after it is brewed. In one embodiment, a reservoir section is the interior of a coffee pot.

In some embodiments, a grinding section and a reservoir section are provided in a single chamber (e.g., the internal volume of container 102). For example, the grinding section and reservoir sections may both be provided in a cylindrical volume. In one embodiment, a grinding section is adjacent to a reservoir section. In another embodiment, a grinding section is provided within a reservoir section. For example, the portion of container 102 may be used as a place both to grind coffee beans and to hold coffee after it is brewed. In certain embodiments, a piston may establish a boundary between a grinding section of a coffee maker and a reservoir section of the coffee maker. For example, piston 138 may separate grinding section 148 of coffee maker 100 from reservoir section 150 of the coffee maker.

In some embodiments, the boundaries of grinding sections and reservoir sections change during use of the coffee maker. For example, as piston 138 is lowered, grinding section 148 becomes smaller and reservoir section 150 becomes larger. The cross-sections of a grinding section and a reservoir section may be the same or different. In some embodiments, elements other than a piston may separate a grinding section of a coffee maker from a reservoir section of the coffee maker. For example, a grinding section and a reservoir section may be separated with a fixed plate. In certain embodiments, a fixed plate divider for a coffee maker may be removable from the container. For example, a user may be able to slide a divider out the side of a container.

Piston 138 may serve as a pressing element. As used herein, a “pressing element” includes any element that directly or indirectly exerts a force or pressure on a material (e.g., coffee grounds). Other examples of pressing elements include, but are not limited to, a threaded plug, a push plate, or a wedge.

Coffee maker 100 may include filter 152. A filter may allow a mixture of water and some water soluble components from the coffee grounds to pass through the filter, but inhibit other materials from passing (e.g., coarse coffee grounds, coffee bean fragments). In some embodiments, a filter may be placed between a grinding section of a container and a reservoir section of the container. Suitable materials and construction for a filter may include, but is not limited to, a wood paper cone, a polypropylene membrane, a nylon mesh, or a metal screen. In certain embodiments, a filter may include a matrix of pores or holes in a piston. In some embodiments, a filter may be integral to a component of a coffee maker (e.g., holes in a metal piston). In other embodiments, a filter may be a stand-alone element (e.g., an paper insert coupled to a piston). In some embodiments, a filter is a reusable part of the coffee maker (e.g., a washable polypropylene basket). In other embodiments, a filter is disposable (e.g., a paper cone).

In certain embodiments, a coffee maker may include a heating element. A heating element may provide heat for brewing coffee, warming coffee, maintaining coffee at a desired temperature, or a combination thereof. Suitable heating elements may include, but are not limited to, resistive electrical elements (e.g., a wire coil), combustible materials (gas, liquid, or solid), or tubes or coils carrying hot fluid. In certain embodiments, a heating element may be a flameless chemical heater. As shown in FIG. 1, coffee maker 100 may include heater 154. Heater 154 may be attached to container 102. In one embodiment, heater 154 is an electrical resistance heater. Heater 154 may be coupled to a power supply, such as a battery or home electrical outlet. In certain embodiments, a heating element may be provided inside a container.

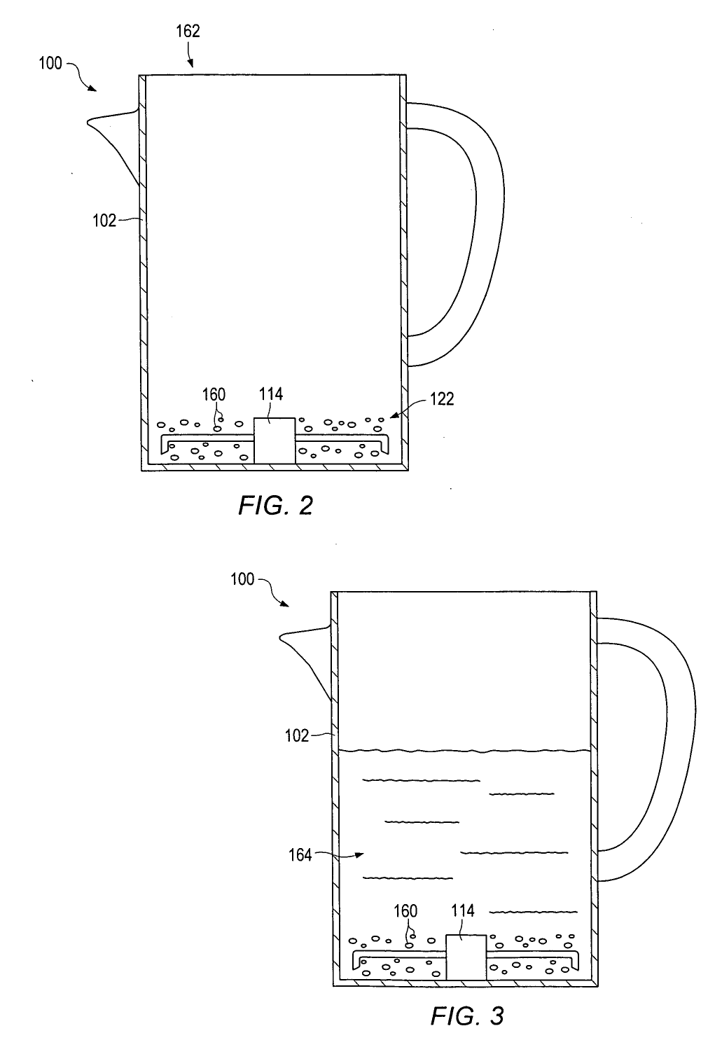

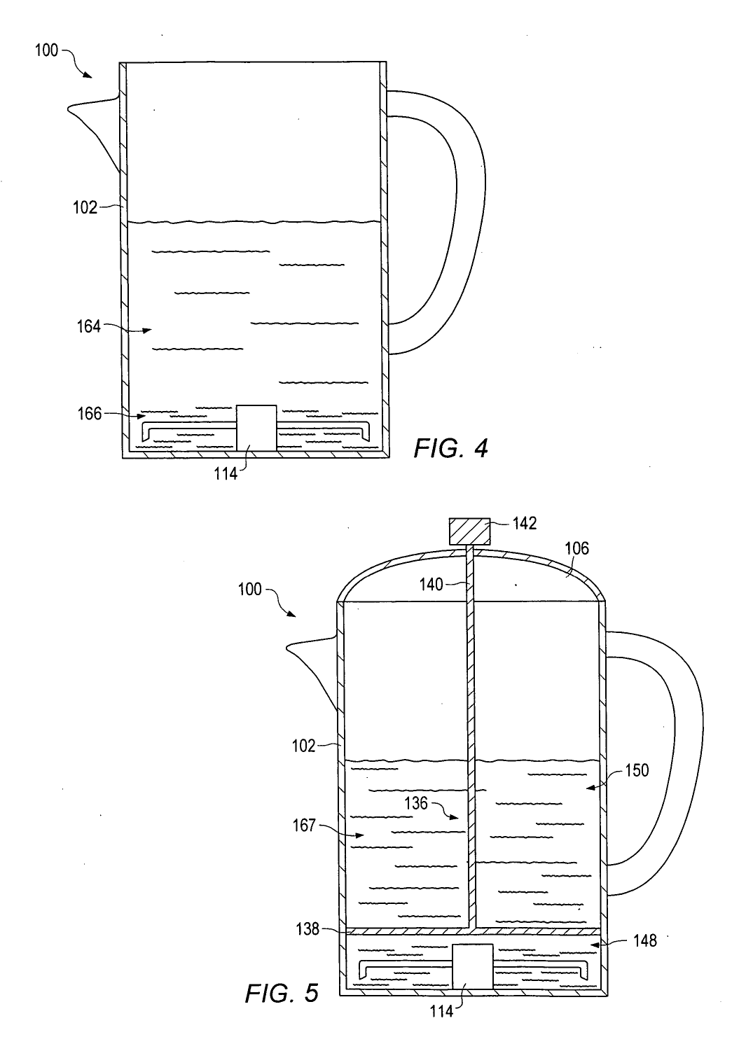

FIGS. 2-5 depict coffee maker 100 as a batch of coffee is made. FIG. 2 depicts coffee maker 100 with lid 106 and plunger 136 removed. Coffee beans 160 may be poured through opening 162 to rest in bottom portion 122 of container 102. In FIG. 2, coffee beans 160 are depicted schematically. Coffee beans may be large or small, and may be of uniform size or varying sizes. As shown in FIG. 3, water 164 may be poured into container 102. In some embodiments, water 164 may cover all of coffee beans 160. In other embodiments, water 164 may only partially cover coffee beans 160. Blade grinder 114 may be operated (e.g., rotated) to chop coffee beans 160 into grounds. Operation of blade grinder 114 may be continued until coffee beans 160 are ground to a desired consistency. In some embodiments, the coffee beans 160 are ground into coarse grounds. Coarse grounds may not pass through filter 154. As shown in FIG. 4, coffee grounds may mix with water 164 to form mixture 166. Grinding coffee beans under water may reduce loss of water soluble components to the environment. Grinding coffee beans under water may result in more flavorful coffee.

Initially, water soluble components from the coffee grounds may be more concentrated near the bottom of container 102. Over time, water soluble components may diffuse throughout water 164. In some embodiments, a user may promote or accelerate mixing of water soluble components with water by agitating a container or materials in the container (by shaking, stirring, etc.) In certain embodiments, the beans are agitated during the brewing process. For example, the beans may be agitated while the mixture is steeping in the container. In certain embodiments, the coffee beans are agitated by operating a grinder. Agitating coffee beans while grinding or brewing may result in a more flavorful batch of coffee. Agitating coffee beans while grinding or brewing may reduce the amount of beans required for a given amount of coffee, thereby reducing the cost to make the coffee.

In some embodiments, all of the water for a batch of coffee may be introduced into a container before grinding the coffee beans. In other embodiments, all of the water for a batch of coffee may be introduced into a container after grinding the coffee beans. In still other embodiments, some of the water for a batch of coffee is introduced into a container before grinding the coffee beans, and the rest of the water for a batch of coffee is introduced into the container after grinding the coffee beans. In certain embodiments, water is added in stages at selected times during the grinding of coffee beans.

In some embodiments, water 164 covering coffee beans 160 during grinding may be hot water. In other embodiments, water 164 covering coffee beans 160 during grinding may be cold water. In certain embodiments, heater 154 may be used to heat water 164 in container 102 to a desired temperature for brewing of the coffee.

After grinding coffee beans 160, coffee grounds may be allowed to steep in hot water 164 for an appropriate length of time. In one embodiment, the coffee grounds may be allowed to steep for about 4 to 5 minutes. Plunger 136 may be re-inserted into container 102. FIG. 5 depicts plunger 136 in container 102. Piston 138 may be gently lowered onto coffee grounds by using knob 142 to advance rod 140 downwardly. When preparation of the coffee is complete, coffee maker 100 may be tipped to pour coffee 167 out of reservoir section 150.

In certain embodiments, coffee may be made without any filtering step. For example, a mixture steep in the bottom of container 102 for an appropriate length of time, then be poured out of container 102. In one embodiment, gravity inhibits the coffee grounds from being dispensed with the coffee when container 102 is tipped. In another embodiment, piston 138 is positioned to filter coffee grounds from the mixture as the container 102 is tipped.

In an alternate embodiment, plunger 136 may be reinserted into container 102 before coffee beans 160 are ground. After grinding coffee beans 164 with plunger 136 in place, coffee grounds may allowed to steep in water 164 for a desired length of time.

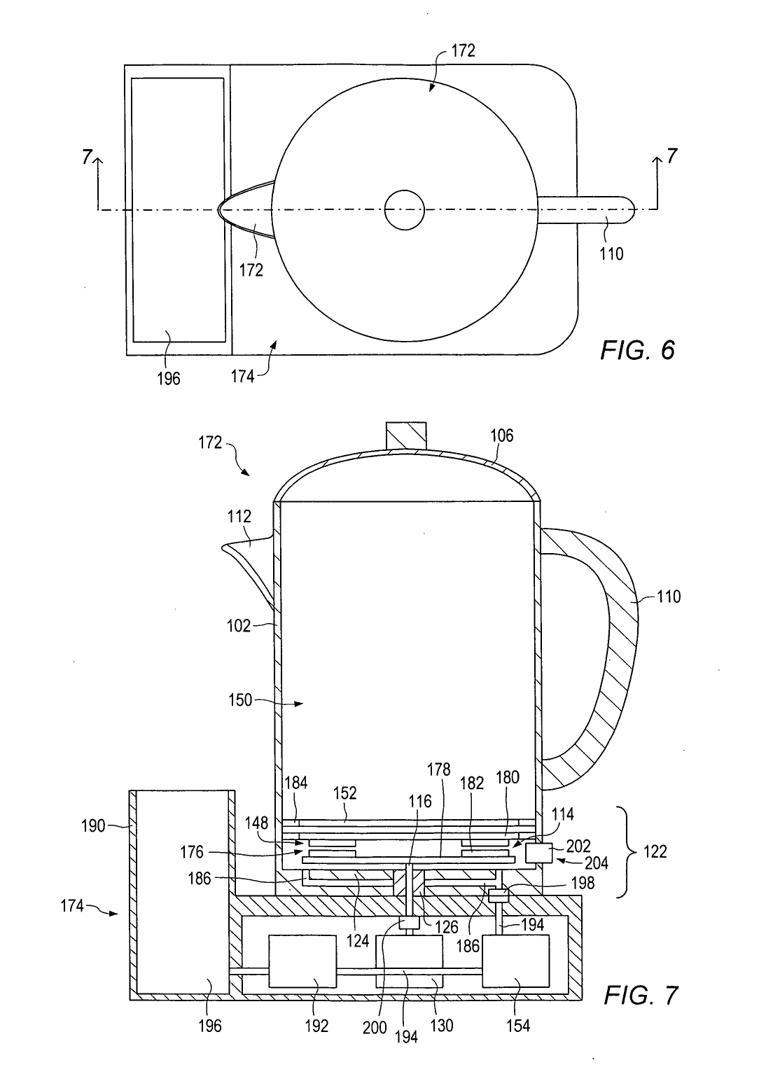

In certain embodiments, a coffee maker may include a stationary base. The stationary base may house some of elements of the coffee maker. FIGS. 6 and 7 depict coffee maker 170 including container unit 172 and base unit 174. Container unit 172 may be removable from base unit 174. Container unit 172 may include container 102, lid 106, and burr grinder 176. Burr grinder 176 may be located in bottom portion 122 of container 102. Lower plate 178 may be rotably coupled on shaft 116 in bottom wall 124 of container 102. Upper plate 180 may be attached to container 102. Lower plate 178 and upper plate 180 may include complementary teeth 182 that grind coffee beans between the plates. Divider 184 may separate reservoir section 150 from grinding section 148. Divider 184 may include filter 152. Bottom wall 124 of container may include manifold 186. Manifold 186 may include multiple inlets for supplying water to grinding section 148.

Base unit 174 may include housing 190, motor 130, pump 192, supply line 194, and heater 154. Housing 190 may include supply tank 196. Pump 192, supply line 194, and supply tank 196 may form a water delivery system. As used herein, a “water delivery system” is a system that delivers water to a portion of a coffee maker (e.g., to a grinding section). Fluid coupling 198 may allow manifold 186 in container unit 172 to be decoupled from supply line 194 in base unit 174. Shaft coupling 200 may allow shaft 116 in container unit 172 to be decoupled from motor 130 in base unit 174.

Coffee beans may be introduced into grinding section 148 of container unit 172. In one embodiment, lid 106 and divider 184 may be removed and coffee beans poured through top of container 102. In another embodiment, plug 202 may be removed and coffee beans introduced through aperture 204. In an alternate embodiment, a user may introduce coffee beans through an aperture that is selectively covered by a door coupled to the container. Container unit 172 may be placed on base unit 174. Pump 192 may draw water from supply tank 196 and pump the water in supply line 194 through heater 154. Water may flow through manifold 186 and into grinding section 148. Burr grinder 176 may be operated to grind the coffee beans into coffee grounds. Continued operation of pump 192 may force a mixture of water and water soluble components from the coffee grounds through filter 152 to yield coffee in reservoir section 150. When the coffee is ready, container unit 172 may be removed from base unit 174 to dispense the coffee.

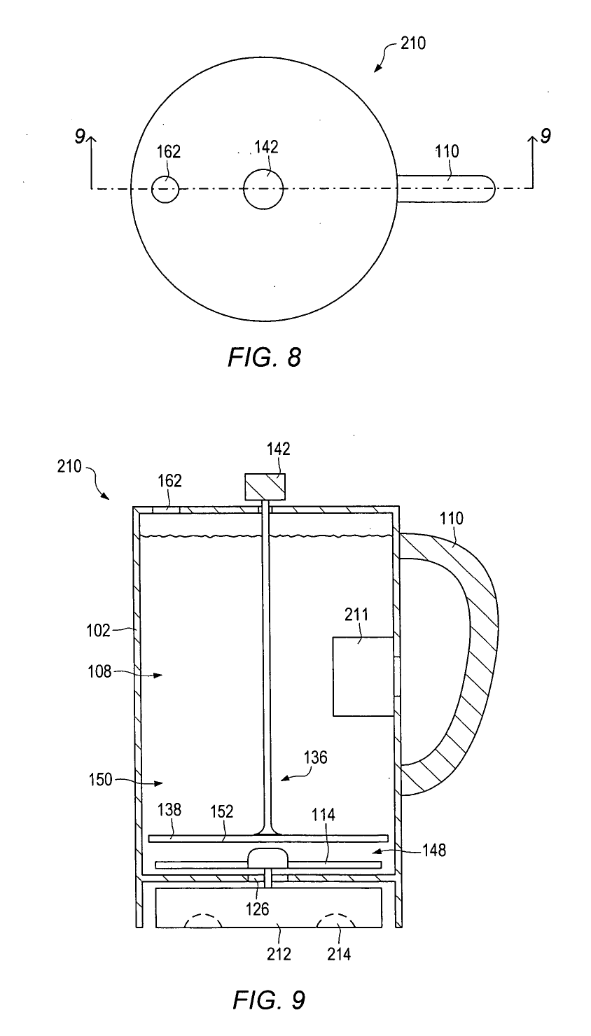

In some embodiments, a coffee maker/dispenser may include built-in grinding and/or heating elements. FIGS. 8 and 9 depict coffee maker 210 including container 102, plunger 136, flameless heating element 211, and handle 110. Coffee maker 210 may include blade grinder 114 in grinding section 148 of coffee maker 210. Coffee maker 210 may include plunger 136. Plunger 136 may include piston 138. Piston 138 may have filter 152.

Blade grinder 114 may be coupled to manual crank 212. Manual crank 212 may include recesses 214. In one embodiment, manual crank 212 is a disc with recesses 214 for the fingers or thumb of a user. In other embodiments, various other driving mechanisms, such as an electric motor, may be used instead of manual crank 212.

In some embodiments, coffee beans 160 may be pre-loaded into grinding section 148 when coffee maker 210 is assembled. In certain embodiments, water may be pre-loaded into container 102 before the coffee maker is provided to a user (e.g., when the coffee maker is assembled). Pre-loading coffee beans and/or water into a coffee maker may allow a user to make a fresh batch of coffee without adding any ingredients to the coffee maker. It will be understood that in other embodiments, coffee beans and/or water may be loaded into container 102 after assembly of coffee maker 210.

In some embodiments, coffee maker 210 produces a single serving of coffee. A user may drink the coffee directly from opening 162 in coffee maker 210. A self-contained coffee maker and dispenser may provide fresh coffee for a user that does not have access to a coffee store (e.g., when the user is camping, hunting, fishing, hiking, or boating). A self-contained coffee maker and dispenser may provide coffee to a user on-the-go (e.g., a user getting into a car for the morning commute, catching a flight). In certain embodiments, coffee maker 210 is a disposable unit.

When a user is ready to make coffee, the user inserts fingers and/or a thumb into the recesses 214 and rotates manual crank 212. Flameless heating element 211 may be activated to heat water in container 102. In one embodiment, flameless heating element 211 may include a magnesium/iron alloy in a porous matrix inside a casing. To activate the heating element, a sodium chloride electrolyte solution may be introduced into the matrix (e.g., by puncturing/tearing a container of water). Heat may pass from the casing of the heating element into water in container 102. Plunger 136 may be operated to apply pressure to coffee grounds in grinding section 148 of container 102. Coffee may be poured out of coffee maker 210 through opening 162.

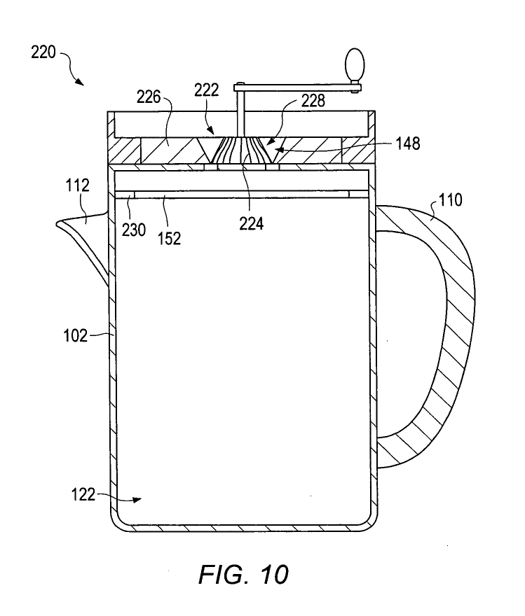

In some embodiments, a coffee maker and dispenser may include a top-loading grinder. FIG. 10 depicts a cross-sectional view of a cylindrical coffee maker 220 including conical burr grinder 222. Conical burr grinder 222 may include center head 224 and annular ring 226. Center head 224 and annular ring 226 may include complementary teeth 228. One or both of center head 224 and annular ring 226 may rotate during operation of conical burr grinder 222.

Coffee maker 220 may include trap 230 below conical burr grinder 222. Trap 230 may include filter 152. Coffee beans may be ground in conical burr grinder 222 and fall through filter into trap 190. After the coffee beans are ground, hot water may be poured through burr grinder. A mixture of hot water and coffee compounds may pass through filter 152 and drop into bottom portion 122 of container 102. Coffee may be dispensed through spout 112.

In certain embodiments, coffee beans may be partially or completely submersed during grinding. For example, trap 230 may hold water in grinding section 148 long enough that coffee beans in conical burr grinder 222 are at least partially submersed in water during grinding. Additional water may be poured into coffee maker 210. Adding additional water may drive the resulting mixture of coffee compounds and water through filter 152.

As used herein, “coupled” includes a direct or indirect coupling unless expressly stated otherwise. For example, a driving mechanism may be directly coupled to a grinding element or indirectly coupled by way of a gearbox.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A coffee maker, comprising:
a reservoir section;
a grinding section coupled to the reservoir section such that fluid can flow from the grinding section to the reservoir section or from the reservoir section to the grinding section;
a grinder at least partially disposed in the grinding section; and
a filter that can be positioned between the grinding section and the reservoir section.

2. The coffee maker of claim 1, further comprising a container, wherein the reservoir section and the grinding section are at least partially defined by an internal volume of the container, wherein the container is configured to allow coffee to be dispensed from the reservoir section.

3. (canceled)

4. The coffee maker of claim 2, wherein the grinding section is at or proximate to the bottom of the internal volume, wherein at least a portion of the reservoir section is at or proximate to the top of the internal volume.

5. The coffee maker of claim 1, wherein the grinder is configured to grind coffee beans while the coffee beans are in water.

6-8. (canceled)

9. The coffee maker of claim 1, further comprising at least one pressing element, wherein the pressing element is configured to apply pressure to the coffee grounds in the grinding section.

10. The coffee maker of claim 9, wherein the coffee maker comprises a container, wherein the at least a portion of the pressing element and at least a portion of the grinder are in the container.

11. The coffee maker of claim 9, wherein the coffee maker comprises a container, wherein the pressing element comprises a piston configured to slide within a portion of the container.

12-13. (canceled)

14. The coffee maker of claim 1, wherein the filter is configured to allow a mixture of water and water soluble components from the coffee grounds to pass into the reservoir section.

15-28. (canceled)

29. A coffee maker, comprising:
a container comprising a reservoir section and a grinding section; and
a grinder coupled to the container, the grinder being configured to grind coffee beans in the grinding section while the coffee beans are in water.

30. The coffee maker of claim 29, wherein the grinding section is configured to hold water and coffee beans such that coffee beans in the grinding section are at least partially submersed in the water.

31. The coffee maker of claim 29, wherein the reservoir section and the grinding section are one section.

32. The coffee maker of claim 29, wherein the coffee maker is configured to agitate the coffee beans in water during brewing.

33. The coffee maker of claim 29, wherein the coffee maker is configured to agitate the coffee beans in water during grinding.

34-36. (canceled)

37. The coffee maker of claim 29, wherein the reservoir section and the grinding section are in a body, wherein the coffee maker is configured to allow coffee to be dispensed from the reservoir section.

38. The coffee maker of claim 29, further comprising at least one pressing element, wherein the pressing element is configured to apply pressure to coffee grounds in the grinding section.

39-40. (canceled)

41. The coffee maker of claim 29, further comprising a heating element configured to heat fluid in the reservoir section.

42-54. (canceled)

55. A method of making coffee, comprising:
at least partially submersing coffee beans in water in a container;
grinding the coffee beans in the container to form coffee grounds;
brewing coffee from the coffee grounds; and
agitating a portion of the coffee beans while the coffee is brewing.

56. The method of claim 56, wherein agitating the coffee beans while the coffee is brewing comprises operating a grinder in the container.

57. The method of claim 56, further comprising pressing the coffee grounds.

58. The method of claim 56, wherein brewing the coffee comprises allowing the mixture to steep in the container.
